(19) United States
(12) Patent Application Publication
(10) Pub. No.: US 2002/0011931 A1
(43) Pub. Date: Jan. 31, 2002

(54) Baggage entertainment devices and methods

(76) Inventors: Ingrid Henry Johnson, Diamond Bar, CA (US); Joey Johnson JR., Diamond Bar, CA (US); Linda Johnson, Diamond Bar, CA (US)

Correspondence Address: Fish & Associates, LLP, Suite 706, 1440 N. Harbor Blvd., Fullerton, CA, 92835, US

(21) Appl. No.: 09/933,650

(22) Filed: Aug. 20, 2001

Related U.S. Application Data
(63) Continuation-in-part of application No. 09/656,534, filed on Sep. 7, 2000.
Application No. 09/656,534 is a continuation-in-part of application No. 09/224,979, filed on Jan. 4, 1999, now Pat. No. 6,121,877.
Application No. 09/224,979 is a continuation-in-part of application No. 08/950,405, filed on Oct. 15, 1997, now abandoned.
(60) Provisional application No. 60/055,858, filed on Aug. 15, 1997.

(51) Int. Cl. G08B 13/14

(52) U.S. Cl. 340/571; 340/540

(57) ABSTRACT

An item of personal accessory baggage has a user-recordable electronic sound recorder and playback device sized to less than 30% of an available carrying volume of the baggage, that reproduces a sound stored by a user and that is actuated upon occurrence of an event other than a movement of the baggage. The baggage preferably has a flap and at least one shoulder straps. Exemplary pieces of baggage are children's knapsacks and woman's or girl's pocketbooks. The recorder/playback device should have sufficient capacity to record at least 120 seconds of speech, although both greater and lesser capacities are also contemplated. The recorder/playback device may have any suitable actuation/control mechanism, and preferably uses a light actuated sensor. The recording/playback device may be constrained to the designated location by mechanical constraint (e.g., a sewn seam, a pouch, Velcro™, etc), a magnet, or chemical (e.g., glue, adhesive, etc).

This application is a continuation-in-part of U.S. Ser. No. 09/656534 filed Sep. 7, 2000, which is a continuation-in-part of U.S. Ser. No. 09/224,979 filed Nov. 16, 1999, which is a continuation-in-part of U.S. Ser. No. 08/950,405 filed Oct. 15, 1997, which claims priority to provisional application Ser. No. 60/055,858 filed Aug. 15, 1997.

### FIELD OF THE INVENTION

The field of the invention is personal baggage.

### BACKGROUND OF THE INVENTION

Personal baggage is generally used to carry clothing, papers, toys, and portable items such as personal hygiene devices, toys, tools, and so forth. Many different types of personal baggage are known, including formal or casual apparel such as handbags and brief cases, travel containers such as suitcases and garment bags, and sporting or educationally directed items such as knapsacks and school bags.

A common element of all baggage it that it provides an available enclosed carrying volume. Where the baggage is designed to carry a single item, the item may fill at least 50%, 60%, 70%, 80%, or even 90% of the available enclosed carrying volume. In such special purpose baggage the carried item is also substantially constrained within the carrying space, so that it cannot move about very much. Examples include a carrying case designed for a Palm Pilot™, or a padded case for a laptop computer. In other instances the baggage may be intended more for general purpose use. Thus, a knapsack or pocketbook are each used to carry any number of items, with many of the items may fill less than 50% of the available enclosed carrying volume, and not particularly constrained as to their locations within the carrying space.

As used herein, the term “personal accessory baggage” means pocketbooks, purses, children's knapsacks, and other types of baggage that are intended to be worn on a person as a clothing accessory. Personal accessory baggage typically, but not necessarily, has flap type closure rather than a full closure such as that found in a suitcase or a typical locking briefcase. One side effect of relying on a flap for closure is that the main carrying compartment(s) of personal accessory baggage can be accessed, albeit sometimes with difficulty, even though the flap is closed. For example, a pocketbook may have a zipper closure covered by a flap. Personal accessory baggage also typically has at least one strap that may be employed in carrying the baggage over the shoulder, and often includes two such straps for wearing on the user's back.

As used herein, the term “children's knapsack” refers to a relatively small backpack favored by children for carrying books and school supplies. The category excludes large backpacks intended for hiking and camping, such as those having rigid frames, hip belts, and so forth.

It is known to carry a user-recordable sound recording and playback device (recording/playback devices) inside pieces of luggage. Along these lines, U.S. Pat. No. 5,500,636 to Mitchell, Mar. 19, 1996, teaches housing a recording/playback device along the inside top of a piece of luggage. Recordings can only be made when the luggage is opened, but playback can be initiated with the luggage closed. This is said to allow a traveler to record relevant destination and identification information on the recording/playback device. The technique may be useful for luggage, but is not especially useful for personal accessory baggage, which is usually carried on the person, or at least kept very close to the person during travel. The Mitchell technique is also contemplated to be too cumbersome for use with personal accessory baggage.

It is also known to dispose recording/playback devices in on pouches affixed to furniture or vehicles. For example, U.S. Pat. No. 5,544,745 to Famorca, Aug. 13, 1996, teaches a piece of baggage intended to be disposed on a wheel chair, bed, or other structure, that has a pouch sized and dimensioned to receive a recording/playback device. Of course, such baggage is not intended to be carried about or otherwise worn on a person as a clothing accessory, and falls outside the definition of personal accessory baggage employed herein.

With respect to personal accessory baggage, it is known for an alarm, which may be a type of recording/playback device, to be hidden inside the baggage. Such devices are known to be activated by movement, to help prevent theft of the baggage. See U.S. Pat. No. 3,701,140 to Dixon, U.S. Pat. No. 5,164,706 to Chen, U.S. Pat. No. 5,434,559, and U.S. Pat. No. 5,043,702 to Kuo.

It is also known for a recording/playback device to simply be carried along with other items in the main cavity of the baggage. Problems arise, however, in that the device can sometimes be difficult to find quickly among many other items. With flap-type personal accessory baggage, the use of a flap may also allow a relatively small recording/playback device to fall out of the baggage and become lost. In such instances there is a need to constrain the recording/playback device to a designated recorder/playback device location within the baggage.

There is also an issue of how much space the recording/playback device occupies with respect to the carrying volume of personal accessory baggage. In many instances the recording/playback device occupies a relatively large portion (defined herein to be at least 30%) of the total available carrying volume of the case.

Thus, there remains a need to provide improved personal accessory baggage having a recording/playback device, that occupies a relatively small percentage of the available carrying volume of the baggage, and that reproduces a sound stored by a user that is actuated upon occurrence of an event other than a movement of the baggage.

### SUMMARY OF THE INVENTION

The present invention is directed to personal accessory baggage having a user-recordable electronic sound recorder and playback device sized to less than 30% of an available carrying volume of the baggage that reproduces a sound stored by a user and that is actuated upon occurrence of an event other than a movement of the baggage.

The baggage is preferably a flap-type baggage, and independently a type of baggage having at least one or two shoulder straps. Exemplary pieces of baggage are children's knapsacks and woman's or girl's pocketbooks.

The recording/playback device may contain any suitable electronic circuitry, and may advantageously be configured to provide or at least assist in providing an alarm. The device may also be configured to record speech, music, or other sounds. The recorder/playback device should have sufficient capacity to record at least 120 seconds of speech, although both greater and lesser capacities are also contemplated.

The recorder/playback device may have any suitable actuation/control mechanism, including a movement actuated switch, or a distally actuated switch. An especially preferred actuator mechanism includes a light sensor, that initiates playback. The recording/playback device may be constrained to the designated location by mechanical constraint (e.g., a sewn seam, a pouch, Velcro™, etc), a magnet, or chemical (e.g., glue, adhesive, etc).

Various objects, features, aspects, and advantages of the present invention will become more apparent from the following detailed description of preferred embodiments of the invention, along with the accompanying drawings in which like numerals represent like components.

### BRIEF DESCRIPTION OF THE DRAWING

FIG. 1A is a front perspective view of a knapsack according to the inventive subject matter, where the flap is in a closed position.

FIG. 1B is an exploded front perspective view of a knapsack according to the inventive subject matter, where the flap is in an open position, and a URSRP device is removed from a carrying pouch.

FIG. 2A is a front perspective view of a pocketbook according to the inventive subject matter, where the flap is in a closed position.

FIG. 2B is a front perspective view of a pocketbook according to the inventive subject matter, where the flap is in an open position.

### DETAILED DESCRIPTION OF THE DRAWING

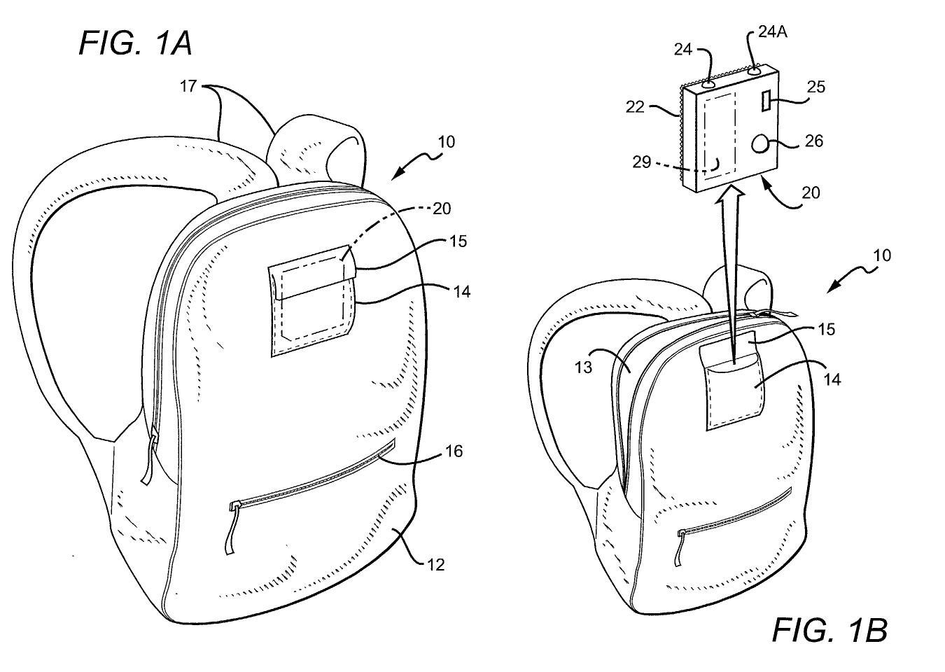

In FIGS. 1A and 1B, a child's knapsack 10 generally comprises a body 12 having a pouch 14 with a flap 15, a zippered pocket 16, and shoulder straps 17. A user-recordable electronic sound recorder and playback device (recording/playback device) 20 is shown in phantom disposed in pouch 14, and in solid lines removed from the pouch 14. The pouch 14, along with main carrying cavity 13 of knapsack 10, and perhaps other pockets and pouches, define the total available carrying volume of the knapsack 10. In that regard it should be noted that the zippered pocket 16 does not add to the total available carrying volume because use of the pocket 16 reduces the volume of main carrying cavity 13.

There is no particular significance to the design of the knapsack as shown in FIG. 1, and indeed the term knapsack is used herein in its broadest generic sense consistent with the descriptions herein. On the other hand, it is contemplated that the total available carrying volume of the knapsack 10 is sufficiently large that the recording/playback device 20 occupies less than 30% of such volume. There is no particular magic to this number, and it is also contemplated that the relative volume of the recording/playback device with respect to the total available carrying volume of the knapsack 10 would provide a corresponding ratio of less than 20%, less than 10%, or even less than 5%. While not preferred, it is also contemplated that such ratio could be less than 40%, less than 50%, or less than 60%.

The designated location for the recording/playback device 20 can be anywhere on or in the baggage. Thus, the designated location may be inside the main carrying area 13, on the underside of flap 15, or in pouch 14 as shown. The location may be “designated” in any suitable manner, including through the use of Velcro™, magnets, glue, and so forth. A constraining pad 22 on the back side of recording/playback device 20 (depicted in phantom) is intended to be viewed generically as Velcro™, a magnet, and a chemical adhesive such as glue. Constraining pad 22 is preferably sufficient to prevent the recording/playback device 20 from inadvertently falling out of the knapsack 10, while still providing relatively easy removal of the device by a user. Constraining the recording/playback device in a relatively fixed position means that the device is not permitted to spatially translate by more than three inches in any direction. More preferable constraints are stricter, providing movement by less than two inches, one half inch, or one third of an inch in any direction.

With current technology the recording/playback device 20 is most likely limited to less than about 20 minutes of voice or music recording. Greater or lesser capacities are also contemplated, however, including recording of more than 30, 40, 50, or 60 minutes, and also less than 15, 10, 5, or two minutes.

Light sensor 24 is affixed at the top of recording/playback device 20, and senses opening and/or closing of the flap 15. In preferred embodiments, opening flap 15 increases the light incident upon light sensor 24, and triggers playback of the recording/playback device 20. Correspondingly, closing flap 15 decreases the light incident upon light sensor 24, and stops playback of the recording/playback device 20. Alternative or additional triggering mechanisms are also contemplated, including switch 25, magnetic sensors, motion sensors, timers, temperature sensors, radio wave or other distance actuated sensors, and so forth, each of which is generically represented by sensor 24A.

Sensors according to the inventive subject matter can thus comprise anything capable of detecting events, can have any reasonable shape and size, and can be located anywhere in relation to the baggage. Thus, the sensor may be fully, or at least partially hidden from external view. In other aspects, the sensor may be either fixed or removable from the baggage, such that a single sensor can be utilized in different backpacks or other pieces of baggage. In other aspects, the sensor can have an on-off switch and/or a volume control which may be static or which may increase or decrease in volume over time. In yet another aspect the sensor may receive a combination or PIN (personal identification) code that can be used in conjunction with turning on, turning off or opening the baggage.

When the sensor detects an event as discussed above, it triggers an action of the recorder/playback device 20. Contemplated actions include start or stop recording, start or stop playing, “rewind”, “fast forward”, power up, power down, and so forth. Some of the played sounds may be prerecorded, such as an entertaining signal, segment of music, chimes or bells, a voice, animal sounds, or a beeping sound or pattern such as that heard on a pager or telephone. The playback may optionally or alternatively comprise another sense modality, such as a blinking light, a smell or a vibration.

As the term is used here, an “entertaining signal” means a signal which is sensible to a typical human, but which is unlikely to produce an alarm reaction in such person. Thus, classical music, pop music, or even rap music played at reasonable sound levels, (for example, less than 80 dB) falls within the term “entertaining signal,” even though the music may be discordant, disharmonious, cacophonous or otherwise unpleasant to some listeners. Similarly, rhythmic or arrhythmic beeping sounds or blinking lights would generally also fall within the term “entertaining signal.” Still further, an “entertaining signal” as the term is used herein includes the “entertainment sound” as defined in U.S. Pat. No. 5,245,666 and U.S. Pat. No. 4,389639, and the “entertaining music” as used in U.S. Pat. No. 4,864,410. By way of further clarification, however, a loud honking, siren or other sound calculated to instill immediate apprehension or other alarm reaction in a typical person would not fall within the term “entertaining signal.”

The circuitry 29 for the recording/playback device can take any suitable form. Such circuitry is well within the ordinary skill in the art, and includes that found in modem digital or analog dictation machines. In preferred embodiments, the playback portion of the circuit is user programmable, so that the user can determine alarm or other playback criteria, and the response or responses that are to be employed in connection with particular circumstances. Thus, movement of the baggage containing the sensor may be programmed to produce a pattern of chimes, while opening of the baggage may produce prerecorded music or sounds from a radio, and the end of a school class period may produce blinking lights. It is also contemplated that the apparatus may be programmed to provide a delay of at least a ½ second between detection of the event and production of the entertaining signal. Similarly, a slow opening motion of the baggage may cause the start of recording, while a fast opening motion may trigger an alarm, or playback.

The circuitry 29 cooperates with speaker (not shown) and microphone (not shown) to play back and record sound. Recorder/playback device 20 may also advantageously be provided with on-off and volume control functionalities (not shown), and a panic button 26, which may trigger an alarm.

In general, both sensor and recording/playback circuitry would utilize a local power source. Where a local power source is used, it can include batteries, capacitors or any number of other portable power sources. The local power source is also preferably user replaceable, and may also be rechargeable. In the case of a rechargeable local power source, the circuitry may be coupled to a power cord for use in recharging. Circuitry 29 is preferably powered by a battery not shown.

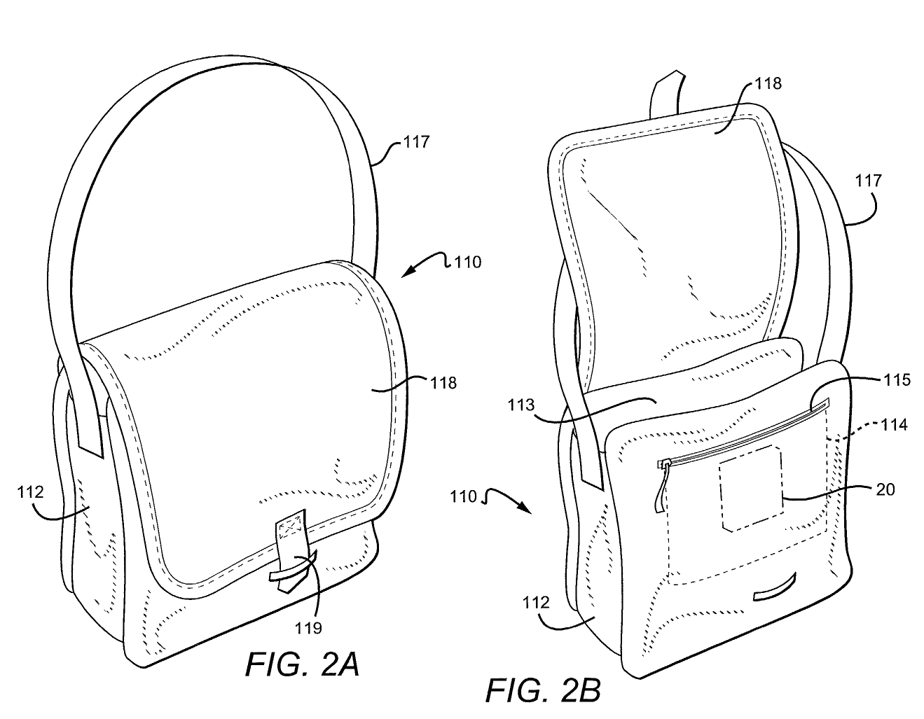

In FIGS. 2A and 2B, a woman's or girl's pocketbook 110 generally comprises a body 112 having a pocket 114 with a zipper 115, hand strap 117, flap 118, and buckle mechanism 119. A user-recordable electronic sound recorder and playback device (recording/playback device) 20 (see FIGS. 1A and 1B) is shown in phantom disposed in pouch 114. The main carrying area of pocketbook 110 is cavity 113. In this instance the total available carrying volume of the pocketbook 110 is sufficiently large that the recording/playback device 20 occupies less than 30% of such volume. Here again, other ratios are contemplated, including less than 20%, less than 10%, or even less than 5%, as well as less than 40%, less than 50%, or less than 60%.

Thus, specific embodiments and applications of methods and apparatus for entertaining have been disclosed. It should be apparent, however, to those skilled in the art that many more modifications besides those already described are possible without departing from the inventive concepts herein. For example, both the knapsack and the sensor mechanism can have any other reasonable size, shape, and configuration, relative position and connection. The inventive subject matter, therefore, is not to be restricted except in the spirit of the appended claims.

What is claimed is:

1. A personal accessory baggage comprising:
a user-recordable electronic sound recorder and playback device sized to less than 30% of an available carrying volume of the baggage that reproduces a sound stored by a user and that is actuated upon occurrence of an event other than a movement of the baggage; and
a designated location for the device that constrains the device in a relatively fixed position with respect to the baggage.

2. The baggage of claim 1, wherein the electronic sound recorder and playback device contains an electronic circuitry configured to assist in providing an alarm.

3. The baggage of claim 2 wherein the alarm is triggered by a safety panic button.

4. The baggage of claim 1 wherein the electronic sound recorder and playback device has sufficient capacity to record at least 120 seconds of speech.

5. The baggage of claim 1, further wherein the electronic sound recorder and playback device has sufficient capacity to record no more than 5 minutes of speech.

6. The baggage of claim 1, further comprising a movement actuated switch cooperatively linked to the electronic sound recorder and playback device to begin at least one of playback and recording.

7. The baggage of claim 1, further comprising a distance actuated sensor cooperatively linked to the electronic sound recorder and playback device to begin at least one of playback and recording.

8. The baggage of claim 1, wherein the electronic sound recorder and playback device is at least partially constrained to the designated location by a mechanical constraint.

9. The baggage of claim 8 wherein the mechanical constraint comprises a sewn seam.

10. The baggage of claim 8 wherein the mechanical constraint comprises Velcro™.

11. The piece of baggage of claim 8 wherein the mechanical constraint comprises a pouch.

12. The piece of baggage of claim 1 wherein the electronic sound recorder and playback device is at least partially constrained to the designated location by a magnetic constraint.

13. The piece of baggage of claim 1 wherein the electronic sound recorder and playback device is at least partially constrained to the designated location by a chemical constraint.

14. The piece of baggage of claim 1 further comprising at least one shoulder strap.

15. The piece of baggage of claim 1 further comprising at least two shoulder straps.

16. The piece of baggage of claim 1, further comprising a flap operatively coupled with an operation of the electronic sound recorder and playback device.

17. The piece of baggage of claim 1, further comprising a light sensor operatively coupled with an operation of the electronic sound recorder and playback device.

18. The piece of baggage of claim 16, further comprising a light sensor and circuitry that triggers playback of the electronic sound recorder and playback device when the flap is opened.
